(19) United States
(12) Patent Application Publication
(10) Pub. No.: US 2009/0320241 A1
(43) Pub. Date: Dec. 31, 2009

(54) HINGING DEVICE FOR TWO TUBES CONSTITUTING A SEAT AND FOR PROTECTING THE HINGING ZONE THEROF

(75) Inventors: Raphael Lazert, Lyon (FR); Yann Le Gal, Biviers (FR)

Correspondence Address: CANTOR COLBURN, LLP, 20 Church Street, 22nd Floor, Hartford, CT, 06103, US

(73) Assignee: LAFUMA S.A., Anneyron (FR)

(21) Appl. No.: 12/302,305

(22) PCT Filed: May 29, 2007
(86) PCT No.: PCT/FR2007/000888

§ 371 Date: Jun. 25, 2009

(30) Foreign Application Priority Data
May 31, 2006 (FR) 0604848

(51) Int. Cl. E05D 7/06

(52) U.S. Cl. 16/239

(57) ABSTRACT

The invention concerns a hinging device (5) for two tubes constituting a seat and for protecting the hinging zone thereof, comprising a first bracket (6) provided with means (7) for fixing a first tube, a second bracket (8) provided with means (9) for fixing a second tube, the brackets (6, 8) being pivotably mounted relative to each other about an axis of rotation (A). The invention is characterized in that one of the brackets (6, 8) comprises a wing (11) extending in a plane substantially perpendicular to the axis of rotation (A), for covering a space delimited between the two tubes over a predetermined length from the axis of rotation (A), whatever the position of the brackets (6, 8) relative to each other.

### BACKGROUND OF THE INVENTION

The invention relates to a hinging device for two tubes constituting a seat and for protecting the hinging zone thereof.

These devices may be used in any kind of hinged structure, in particular for baby carriers worn on the back which can also be used as seats.

### DESCRIPTION OF THE PRIOR ART

A baby carrier of this type is described in document FR 2 170 385. It comprises a tubular frame, a soft seat supported by this frame and a harness attached to the frame which is put on over the shoulders so as to wear the baby carrier.

It also comprises a generally U-shaped tubular stand, the ends of which are pivotably mounted on two tubes of the frame, via a hinging device.

When the stand is retracted, i.e. next to the frame, the baby carrier is more compact and may thus be in the use position on the wearer's back, or in the storage position.

When the stand is extended, i.e. making an angle with the frame, the baby carrier can be placed on the floor without it toppling over, even if a child is in the baby carrier.

However, when the stand is closed the space between the stand and the frame is very small. This space therefore represents a danger for the child or user, whose fingers could get caught as the stand is retracted.

More particularly, this danger is present in the area close to the axis of rotation of the stand relative to the frame. Specifically, if the stand is manipulated via the handling end thereof, the end opposite the end attached to the hinging device, the force that would be exerted on a finger present in the area close to the axis of rotation is very high, due to the lever arm effect.

Protection devices exist, comprising flexible sleeves which are attached to the hinging device and cover the abovementioned area at least partially.

However, these devices do not provide maximum protection, as the child or user can still put their fingers between the frame and the stand because the sleeves are flexible.

### SUMMARY OF THE INVENTION

The invention thus aims to overcome these drawbacks by proposing a hinging device for two tubes and for protecting the hinging zone thereof, preventing fingers from getting caught between the two tubes in the danger zone close to the hinge.

To this end the invention relates to a hinging device for two tubes constituting a seat and for protecting the hinging zone thereof, comprising a first bracket provided with means for fixing a first tube and a second bracket provided with means for fixing a second tube, the brackets being pivotably mounted relative to each other about an axis of rotation,

characterized in that at least one of the brackets comprises a rigid wing extending in a plane substantially perpendicular to the axis of rotation, for covering the space defined between the two tubes over a predetermined length from the axis of rotation, whatever the position of the brackets relative to each other.

The protective wing thus protects a zone of predetermined length extending from the axis of rotation.

The danger zone is therefore completely covered by a rigid wing such that it is impossible to get one's fingers into this zone.

Advantageously, each of the two brackets comprises a wing, the wings overlapping at least partially.

Having two wings allows a relatively large degree of movement between the two tubes with small wings, and hence allows the hinging and protection device to be more compact.

Preferably, at least one bracket comprises stop means, limiting the movement of the brackets relative to each other.

The stop can thus limit the scope of rotation to that permitted by the size of the wings, i.e. to that for which the entire zone close to the axis of rotation is covered by the wings, to ensure said hinging device is safe.

According to a feature of the invention, the stop means comprise a stud projecting from one of the two wings, engaged in a curved slot or groove centered on the axis of rotation of the two brackets and made in the other wing.

The maximum degree of movement is thus comprised between two limit positions of the stud in the groove or in the slot, in which the stud abuts against the corresponding end of the groove or slot.

According to an additional feature, the hinging and protection device comprises means for locking the brackets relative to each other, in at least one predetermined angular position of the two brackets.

Advantageously, the locking means are designed to immobilize the brackets in at least two angular positions.

These two positions may thus correspond to an open position and a closed position of the hinging device.

Preferably, the two brackets comprise two tubular portions, made on the face of each bracket opposite the face for fixing the tubes, forming two half-shells nested one inside the other and containing the axis of rotation, the two half-shells defining a volume for housing a locking element that can move in translation along the axis of rotation between a locked position and an unlocked position.

According to one embodiment, the locking element is substantially cylindrical and comprises at least one radially projecting locking protuberance intended, in a first position, to be engaged in two aligned notches made in the two half-shells and, in a second position, to be engaged only in one of the notches of one of the two half-shells to allow the other half-shell to rotate.

The locking element therefore cannot rotate relative to one of the two brackets, whether the device is locked or not.

This locking element, which can move in translation, locks the two brackets together in terms of rotation when the protuberance is engaged in two facing notches made in the two half-shells. The hinging device is thus locked.

When this locking element is located in only one of the two brackets, the brackets can rotate relative to each other. The hinging device is thus unlocked.

Advantageously, the half-shell which can pivot relative to the half-shell regarding which the locking element cannot rotate comprises two sets of notches, angularly offset by an angle corresponding to two angular positions of the two tube brackets.

These two positions can thus in particular respectively correspond to closed and open angular positions of the hinging device.

According to a feature of the invention, one face of the locking element is subject to the action of elastic means placed between it and the bottom of the half-shell regarding which the locking element cannot rotate, the opposite face of the locking element being subject to the action of a push-button accessible via a central opening made in the bottom of the other half-shell.

Thus, when the locking element is subject only to the elastic means, the hinging device is locked.

When the operator presses on the push-button, against the action of the elastic means, the locking element sinks into one of the half-shells and the other half-shell can rotate.

Preferably, the height of the notches, i.e. the dimension along the axis of rotation, of the half-shell regarding which the locking element cannot rotate is at least equal to the height of the protuberances. The protuberance of the locking element can thus be housed completely inside the corresponding notch in the unlocked position.

According to an additional feature, the means for fixing the tubes are located at least partially on the wings.

The invention also relates to a baby carrier worn on the back comprising a tubular frame for supporting a seat and for hinging the two ends of a generally U-shaped stand, characterized in that the stand is hinged to the frame at each point via a device according to the invention.

### DESCRIPTION OF THE DRAWING

In any case, the invention will be clearly understood with the aid of the following description, referring to the appended schematic drawing which shows, by way of non-limiting example, one embodiment of this hinging device.

### DESCRIPTION OF THE PREFERRED EMBODIMENTS

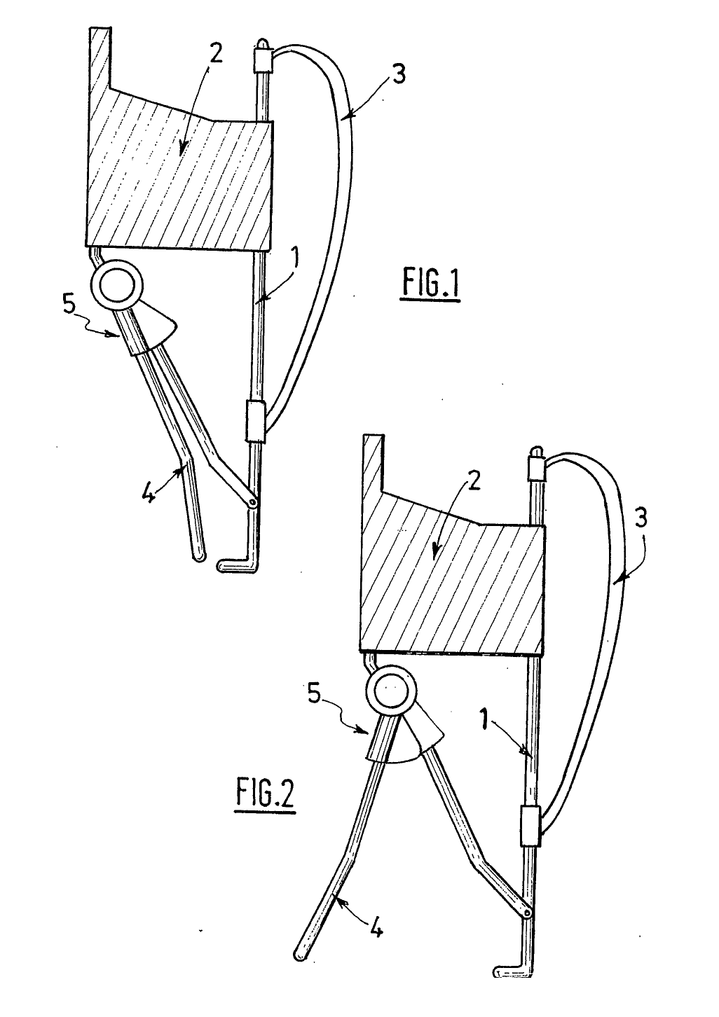

FIG. 1 is an overall view of the baby carrier with the stand in the retracted position;

FIG. 2 is a view like FIG. 1, with the stand in the extended position;

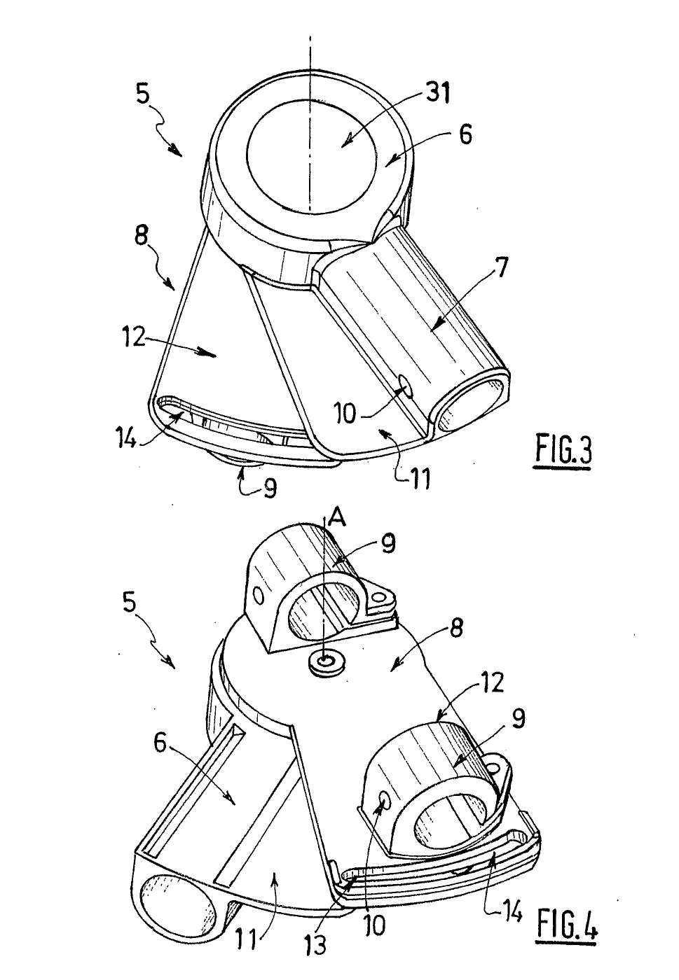

FIGS. 3 and 4 are perspective views, from above and below respectively, of a hinging device for two tubes, with the stand in the extended position;

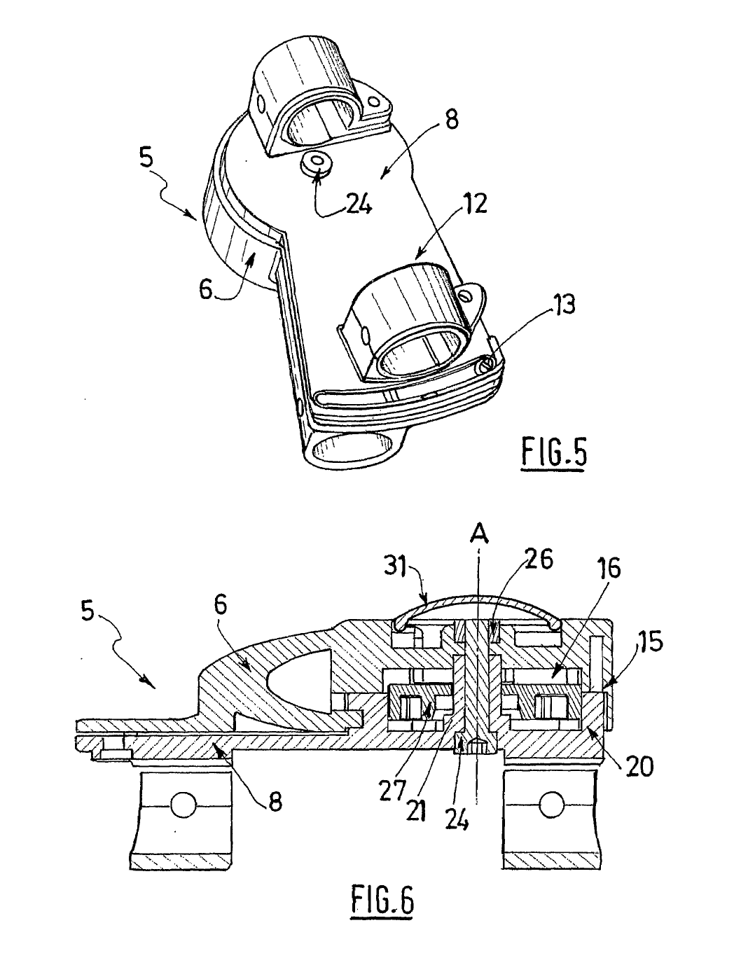

FIG. 5 is a perspective view, from below, with the stand in the retracted position;

FIGS. 6 and 7 are views in section along the diameter of the device, in the locked and unlocked positions, respectively;

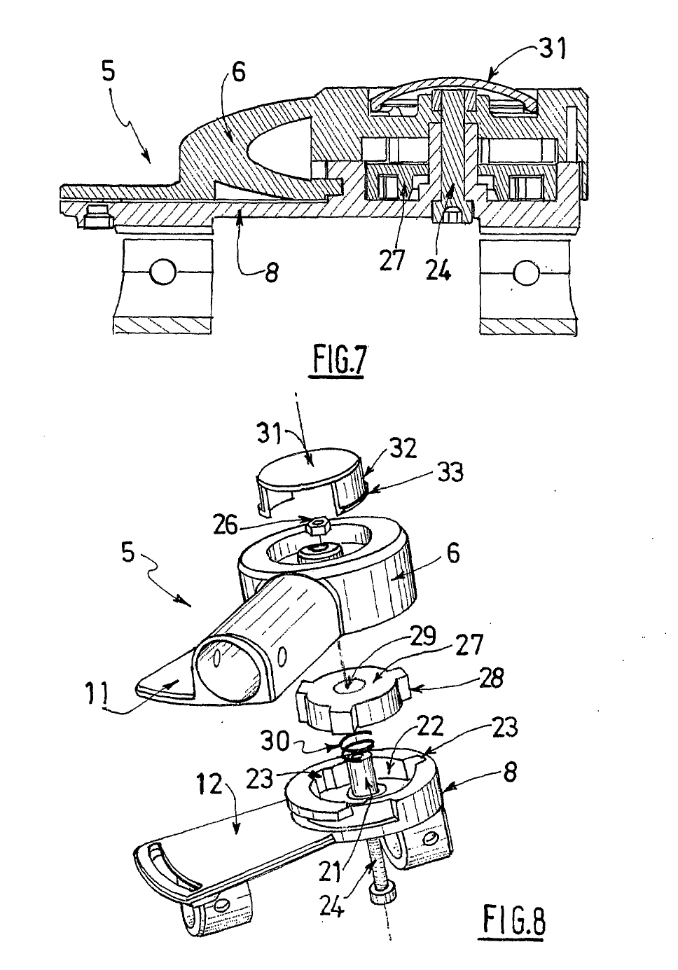

FIG. 8 is an exploded perspective view of this hinging device; and

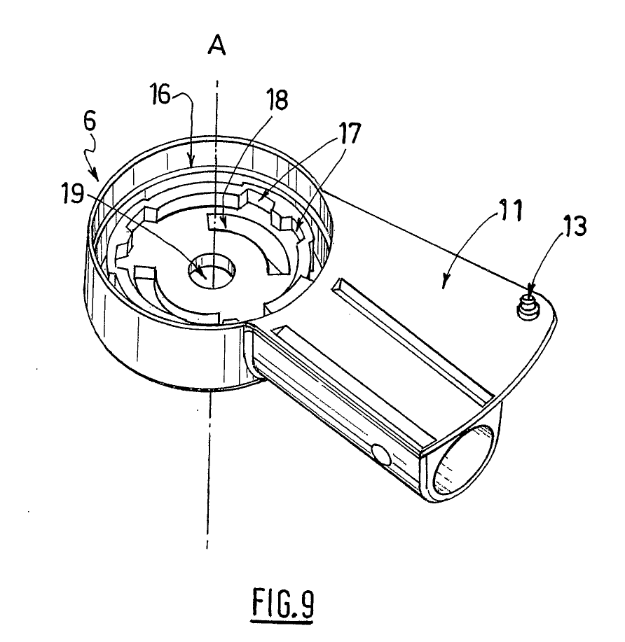

FIG. 9 is a view from below of the bracket for the tube of the stand.

### FIG. 1 shows a baby carrier comprising, as known per se, a tubular frame 1, a soft seat 2 supported on this frame 1 and a harness 3 attached to the frame, with straps which are put on over the wearer's shoulders so as to wear the baby carrier.

The baby carrier also comprises a generally U-shaped tubular stand 4, pivotably mounted on the tubular frame 1 at each of its ends, via a hinging and protection device 5.

When the stand 4 is retracted, i.e. next to the frame 1, as shown in FIG. 1, the baby carrier is more compact and is in the use position on the wearer's back, or in the storage position.

When the stand 4 is extended, as shown in FIG. 2, i.e. making an angle with the frame, the baby carrier can be placed on the floor without it toppling over, even if a child is in the baby carrier.

FIGS. 3 and 4 show the hinging and protection device 5 in the open angular position, corresponding to the position in which the stand 4 is extended.

For the sake of visibility, the tubes of the frame 1 and stand 4 have not been shown in the drawing.

The hinging and protection device 5 comprises a first bracket 6 provided with means 7 for fixing a first tube and a second bracket 8 provided with means 9 for fixing a second tube, the brackets being pivotably mounted relative to each other about an axis of rotation A.

The means for fixing the first tube comprise a tubular portion 7 in which the corresponding tube is inserted. Radial through-holes 10 are also made in the wall of the tubular portion 7 to allow for the passage of pressure screws for immobilizing the tube relative to the first bracket.

The means for fixing the second tube are shown more particularly in FIG. 4.

These comprise two clamping collars 9 which have screws (not shown in the drawing).

As above, a through-hole 10 for the passage of a pressure screw is made in each of the clamping collars.

Each of the two brackets 6, 8 has a wing 11, 12, respectively, extending in a plane substantially perpendicular to the axis of rotation A, for covering the space defined between the two tubes over a predetermined length from the axis of rotation A, whatever the position of the brackets 6, 8 relative to each other.

The wings 11, 12 are positioned in such a way that they overlap when one bracket pivots relative to the other.

The wings also have stop means, limiting the movement of the brackets relative to each other. These means comprise a stud 13 projecting from one of the two wings 11, engaged in a curved slot 14 which is made in the other wing 12 and centered on the axis of rotation A.

FIG. 5 shows a hinging and protection device in the closed angular position, i.e. when the stand is retracted. In this case, the axes of the tubes make an angle between them, as shown in FIGS. 1 and 5. This angle is small, preferably around 5°.

FIG. 6 shows a view in section along the diameter of the hinging and protection device 5.

As can be seen in this figure, the first bracket 6, corresponding to the bracket for the tube of the stand 4, comprises a peripheral tubular portion 15 made on the face that faces the second bracket 8, i.e. on the face opposite the face for fixing the tube.

The first bracket 6 thus forms a first half-shell.

Said half-shell defines a substantially cylindrical cavity 16 which opens toward the second bracket 8 and comprises two sets of three peripheral notches 17, the notches 17 of one set being regularly spaced apart and each set being angularly offset by an angle of around 30°, as shown more particularly in FIG. 9.

The first half-shell also comprises two openings 18 made in the outer wall thereof. These openings 18 are substantially in the form of a quarter of a circle, centered on the axis of rotation A and offset from one another by around 180°.

A central tubular hole 19 is also made in this outer wall, the axis of the hole 19 corresponding substantially to the axis of rotation A of the hinging device.

The second bracket 8, corresponding to the bracket for the tube of the frame 1, comprises a peripheral tubular portion 20 and an axial tubular portion 21, i.e. extending along the axis of rotation A. These tubular portions 20, 21 are made, as above, on the face opposite the face for fixing the tubes, i.e. the face that faces the first bracket 6.

The second bracket 8 thus forms a second half-shell that nests in the first half-shell.

The second half-shell defines a cavity 22 similar to that of the first bracket 6, which opens toward the latter and comprises a single set of three peripheral notches 23, regularly spaced apart, in the same arrangement as one set of three notches 17 of the cavity 16.

These notches 23 face those of one of the two sets of notches 17 made in the first bracket 6, when the hinging device 5 is in the closed position.

Furthermore, these notches 23 of the second bracket 8 face those of the other set of notches 17 of the first bracket 6, when the hinging device 5 is in the open position.

The axial tubular portion 21 of the second bracket is intended for the passage of a securing screw 24, the head of which bears on the outer wall of the second bracket 8.

A nut 26 assembled to the other end of the screw 24, embedded in the first bracket 6, bears on the latter so as to axially secure the two brackets 6, 8 together.

The brackets 6, 8 are thus pivotably mounted relative to each other, about an axis of rotation A defined by the shaft of the screw 24 and the axial tubular portion 21 of the second bracket 8.

Once nested, the two half-shells define a volume for housing a locking element 27 that can move in translation along the axis of rotation A between a locked position and an unlocked position.

The locking element 27, which can be seen more particularly in FIG. 8, is of substantially tubular shape and comprises three radially extending protuberances 28, regularly spaced apart around the periphery of the locking element 27 and intended to engage with the notches 17, 23 made in the first and second brackets 6, 8, respectively.

This element also has a central hole 29 through which the axial tubular portion 21 of the second bracket 8 passes. Furthermore, the height of the protuberances 28 along the axis of rotation A corresponds to the height of the notches 23 of the second bracket 8.

A helical compression spring 30 is placed around the axial tubular portion 21. This spring bears at a first end against the bottom of the cavity 22 of the second bracket 8 and, at the other end, against the corresponding face of the locking element 27.

The hinging and protection device 5 also comprises a push-button 31 having two legs 32 extending in the direction of the axis of rotation A. The legs 32 have a cross section in the form of a quarter of a circle, complementing the openings 18 made in the first bracket 6, and are engaged and guided in said openings.

The push-button 31 is positioned in the first bracket 6 in such a way that one domed actuation end faces outward, the free end of the legs 32 bearing on the corresponding face of the locking element 27.

Each leg 32 also has snap-fastening means 33 that engage with a shoulder made in the first bracket 6 so as to secure the push-button 31 to the bracket 6, while allowing the button 31 to move in translation along the axis of rotation A.

The way in which the locking means work is shown more particularly in FIGS. 6 and 7.

First, when the user is not pressing on the push-button 31, the spring 30 keeps the locking element 27 in the high position, as shown in FIG. 6.

In this position the hinging device 5 is locked.

In this state, when the stand 4 is retracted, the protuberances 28 of the locking element 27 are engaged both in the first set of notches 17 of the first bracket 6 and in the notches 23 of the second bracket 8.

Thus, the two brackets 6, 8 and the locking element 27 are immobilized in terms of rotation, preventing any relative movement between the two brackets 6, 8.

Second, when the user presses on the push-button 31, pressing against the action of the compression spring 30, the locking element 27 is pushed into the low position, as shown in FIG. 7.

In this position the hinging device 5 is unlocked.

In this state, the locking element 27 is housed completely inside the cavity 22 of the second bracket 8 and the two brackets 6, 8 are no longer prevented from rotating.

The first bracket 6 can thus be pivoted, to extend the stand 4.

When the stand is extended, the notches 17 which constitute the second set of the first bracket 6 face the notches 23 of the second bracket 8.

Third, by releasing the push-button 31, the user causes the locking element 27 to rise up again, via the spring 30, so that the hinging device 5 is locked once again.

Note that whatever the state of the hinging and protection device 5, the locking element 27 cannot rotate relative to the second bracket 8.

As the stand is hinged at the ends of its two arms via a device 5 to the frame 1, the two devices 5 should be operated simultaneously to bring the stand 4 from one position into the other.

Naturally, the invention is not limited to the single embodiment of this system described above by way of example, but on the contrary encompasses all variants thereof. Thus, in particular, the hinging device could be used for other hinged structures such as folding tubular chairs or seats.

1. A hinging device for two tubes constituting a seat and for protecting the hinging zone thereof, comprising
a first bracket provided with means for fixing a first tube and a second bracket provided with means for fixing a second tube, the brackets being pivotably mounted relative to each other about an axis of rotation,
wherein at least one of the brackets comprises a rigid wing extending in a plane substantially perpendicular to the axis of rotation, for covering the space defined between the two tubes over a predetermined length from the axis of rotation, whatever the position of the brackets relative to each other.

2. The hinging and protection device as claimed in claim 1, wherein each of the two brackets comprises a wing, the wings overlapping at least partially.

3. The hinging and protection device as claimed in claim 2, wherein at least one bracket comprises stop means, limiting the movement of the brackets relative to each other.

4. The hinging and protection device as claimed in claim 3, wherein the stop means comprise a stud projecting from one of the two wings, engaged in a curved slot or groove centered on the axis of rotation of the two brackets and made in the other wing.

5. The hinging and protection device as claimed in claim 1, further comprising means for locking the brackets relative to each other, in at least one predetermined angular position.

6. The hinging and protection device as claimed in claim 5, wherein the locking means are designed to immobilize the brackets in at least two angular positions.

7. The hinging and protection device as claimed in claim 5, wherein the two brackets comprise two tubular portions made on the face of each bracket opposite the face for fixing the tubes, forming two half-shells nested one inside the other and containing the axis of rotation, the two half-shells defining a volume for housing a locking element that can move in translation along the axis of rotation between a locked position and an unlocked position.

8. The hinging and protection device as claimed in claim 7, wherein the locking element is substantially cylindrical and comprises at least one radially projecting locking protuberance intended, in a first position, to be engaged in two aligned notches made in the two half-shells and, in a second position, to be engaged only in one of the notches of one of the two half-shells to allow the other half-shell to rotate.

9. The hinging and protection device as claimed in claim 8, wherein the half-shell which can pivot relative to the half-shell regarding which the locking element cannot rotate comprises two sets of notches, angularly offset by an angle corresponding to two angular positions of the two tube brackets.

10. The hinging and protection device as claimed in claim 7, wherein one face of the locking element is subject to the action of elastic means placed between it and the bottom of the half-shell regarding which the locking element cannot rotate, the opposite face of the locking element being subject to the action of a push-button accessible via a central opening made in the bottom of the other half-shell.

11. The hinging and protection device as claimed in claim 8, wherein the height of the notches, comprising the dimension along the axis of rotation, of the half-shell regarding which the locking element cannot rotate is at least equal to the height of the protuberances.

12. The hinging and protection device as claimed in claim 2, wherein the means for fixing the tubes are located at least partially on the wings.

13. A baby carrier worn on the back comprising a tubular frame for supporting a seat and for hinging the two ends of a generally U-shaped stand, wherein the stand is hinged to the frame at each point via a device as claimed in any claim 1.
